(19) United States
(12) Patent Application Publication
(10) Pub. No.: US 2024/0375001 A1
(43) Pub. Date: Nov. 14, 2024

(54) GAME SYSTEM, CONTROL PROGRAM, AND CONTROL METHOD

(71) Applicant: KONAMI DIGITAL ENTERTAINMENT CO., LTD., Tokyo (JP)

(72) Inventors: Kazuya Matsumoto, Tokyo (JP); Yukihiro Yamazaki, Tokyo (JP); Yusuke Kobayashi, Tokyo (JP)

(73) Assignee: KONAMI DIGITAL ENTERTAINMENT CO., LTD., Tokyo (JP)

(21) Appl. No.: 18/779,725

(22) Filed: Jul. 22, 2024

Related U.S. Application Data
(63) Continuation of application No. PCT/JP2023/000989, filed on Jan. 16, 2023.

(30) Foreign Application Priority Data
Jan. 25, 2022 (JP) 2022-009195

(51) Int. Cl. A63F 13/533; A63F 13/69

(52) U.S. Cl. CPC A63F 13/533; A63F 13/69

(57) ABSTRACT

A game system, that creates an object group with which a plurality of objects is associated, has: a computer that causes candidate object information, which indicates candidate objects to be associated with the object group, to be displayed on a screen; the computer that performs change processing including at least one of a selection change of associating a selected object selected from the candidate objects with the object group, or a cancellation change of cancelling association between the selected object and the object group; the computer that saves change information indicating that the change processing has been performed in association with object identification information for identifying a change object that has become a target of the change processing; and the computer that causes change object information indicating the change object to be displayed in a different mode from the candidate object information with reference to the change information.

### BACKGROUND OF THE INVENTION

### Field of the Invention

The present invention relates to a game system, a control program, and a control method for displaying a change object.

### Description of the Related Art

Patent Literature 1 describes a game system in which a user battles another user using a card incorporated in a deck. In this game system, the user edits the deck by selecting a card to be added to the deck. Further, Patent Literature 2 discloses a game system including a second display control means. The second display control means causes a display means to display second object information for specifying an object added to an object group.

### CITATION LIST

### Patent Literature

Patent Literature 1: JP2017-196338A
Patent Literature 2: JP2019-136125A

### SUMMARY OF THE INVENTION

A game system may provide a game using an object group, for example, a deck. A plurality of objects is associated with the object group. For example, in the case of a deck, a plurality of cards each of which is a virtual game medium is associated with the deck. In such a game, the deck includes a plurality of associated cards. Then, there are an infinite number of combinations of cards included in the deck, the user creates the deck by repeating addition or removal of cards through trial and error. In this case, while creating the deck, the user may become unable to know which card was added to the deck or excluded from the deck. Moreover, it is a great effort for the user to search for an added or excluded card from a large number of candidates. Therefore, creation of the deck is complicated for the user, and a large burden is imposed on the user.

A game system according to one aspect is a game system that creates an object group with which a plurality of objects is associated, the game system comprising: a computer that causes candidate object information, which indicates candidate objects to be associated with the object group, to be displayed on a screen; the computer that performs change processing including at least one of a selection change of associating a selected object selected from the candidate objects with the object group, or a cancellation change of cancelling association between the selected object and the object group; the computer that saves change information indicating that the change processing has been performed in association with object identification information for identifying a change object that has become a target of the change processing; and the computer that causes change object information indicating the change object to be displayed in a different mode from the candidate object information with reference to the change information.

In addition, a computer-readable non-transitory storage medium storing a control program according to another aspect stores a control program for a game system that creates an object group with which a plurality of objects is associated, the control program causing a computer to: cause candidate object information, which indicates candidate objects to be associated with the object group, to be displayed on a screen; perform change processing including at least one of a selection change of associating a selected object selected from the candidate objects with the object group, or a cancellation change of cancelling association between the selected object and the object group; save change information indicating that the change processing has been performed in association with object identification information for identifying a change object that has become a target of the change processing; and cause change object information indicating the change object to be displayed in a different mode from the candidate object information with reference to the change information.

Moreover, a control method according to another aspect is a control method for a game system that creates an object group with which a plurality of objects is associated, the control method comprising: causing candidate object information, which indicates candidate objects to be associated with the object group, to be displayed on a screen; performing change processing including at least one of a selection change of associating a selected object selected from the candidate objects with the object group, or a cancellation change of cancelling association between the selected object and the object group; saving change information indicating that the change processing has been performed in association with object identification information for identifying a change object that has become a target of the change processing; and causing change object information indicating the change object to be displayed in a different mode from the candidate object information with reference to the change information.

Thereby, when the object group is created, the burden on the user is reduced.

### BRIEF DESCRIPTION OF THE DRAWINGS

FIG. 1 is a schematic diagram illustrating an overall configuration of a game system.

FIG. 2 is a schematic block diagram of a game system.

FIG. 3 is a schematic view illustrating a mode of selecting a card on a composition screen.

FIG. 4 is a schematic diagram illustrating an example of data storage of change information.

FIG. 5 is a schematic diagram illustrating another example of data storage of the change information.

FIG. 6 is a schematic view illustrating a display mode of a change card on the composition screen.

FIG. 7 is a schematic flowchart of display processing of a change object.

FIG. 8 is a schematic view illustrating a display mode of a change object.

### DESCRIPTION OF THE EMBODIMENTS

Hereinafter, exemplary embodiments for carrying out the present invention will be described in detail with reference to the drawings. However, the dimensions, materials, shapes and relative positions of the components described in the following embodiments can be arbitrary set and can be changed according to the configuration of a method or an article to which the present invention is applied or to various conditions. Unless otherwise specified, the scope of the present invention is not limited to the embodiments specifically described below.

### First Embodiment

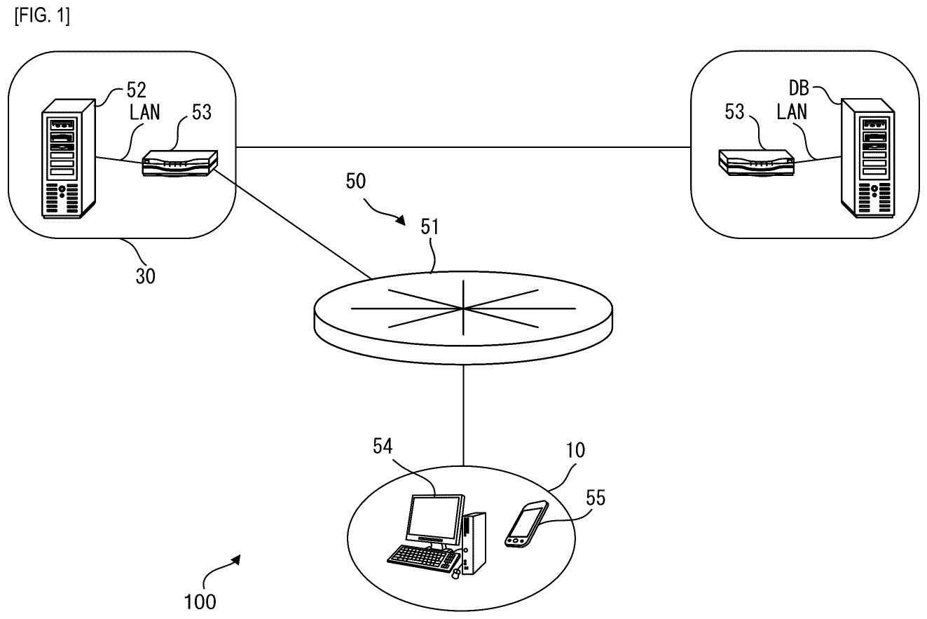

FIG. 1 is a schematic diagram illustrating an overall configuration of a game system 100. As illustrated in FIG. 1, the game system 100 includes a game terminal 10 which is an example of a user terminal, a server 30, and a database DB. The server 30 is configured as one logical server by combining a plurality of server units 52 each functioning as a computer. However, the server 30 may be configured by a single server unit 52. Alternatively, the server 30 may be logically configured by using cloud computing. Then, the server 30 accesses the database DB constructed in a server computer different from the server 30. Alternatively, the database DB may be constructed in the server 30.

The server 30 is configured to be connectable to the network 50. As an example, the network 50 is configured to implement network communication by using a TCP/IP protocol. Specifically, the local area network LAN connects the server 30 and the Internet 51. Then, the Internet 51 as a WAN and a local area network LAN are connected via a router 53. In addition, the game terminal 10 is also configured to be connected to the Internet 51. The server 30 and the database DB may be connected to each other by a local area network LAN or the Internet 51. Incidentally, the network 50 may be any of a dedicated line, a telephone line, an in-enterprise network, a mobile communication network, other communication lines, combinations thereof, and the like, and may be wired or wireless.

The game terminal 10 is a computer device operated by a user. For example, the game terminal 10 includes a stationary or book type personal computer 54 and a mobile terminal device 55 such as a mobile phone (including a smartphone). In addition, various computer devices such as a stationary home game device, a portable game device, a portable tablet terminal device, and a commercial game machine are included in the game terminal 10. The game terminal 10 can cause the user to enjoy various services provided by the server 30 by implementing various types of computer software.

As an example, a program and data used for a game are transmitted from the server 30 to the game terminal 10 via the network 50. Then, the game terminal 10 stores the received program and data. Further, the server 30 can access the database DB directly or via the network 50. Then, the server 30 acquires the program and the data used for the game from the database DB and stores the program and the data. The game terminal 10 and the server 30 may be configured to read a program or data stored in an information storage medium (not illustrated). In this case, the game terminal 10 or the server 30 may acquire the program or data via the information storage medium.

Furthermore, in the following description, identification information for identifying an account of each user is referred to as user identification information. For example, when the user has an account in each game terminal 10, the account of each game terminal 10 can be identified by the user identification information. Further, identification information for identifying each object is referred to as object identification information. Further, identification information for identifying each card is referred to as card identification information. Further, identification information for identifying each deck is referred to as deck identification information. As an example, the identification information is data configured by characters, numbers, symbols, images, or a combination thereof. In addition, the identification information may be displayed on the display apparatus in such a mode that the user can visually recognize the identification information.

### Outline of Game

In the game system 100, an object group, with which a plurality of objects is associated, is created. Then, the user can play a game using the created object group on the game terminal 10. As an example, the game is a battle type trading card game, a music game, a board game, a mahjong game, an RPG game, a fighting game, a puzzle game, a quiz game, a simulation game, a sports game such as baseball and soccer, and the like. Further, the objects are targets to be displayed or used in the game terminal 10. As an example, the objects are used in game processing for progressing the game, and includes a card, a character, a magic, a trap, a monster, an effect, equipment, an item, and the like.

The object group is a group of objects with which a plurality of objects is associated. Examples of the object group include an object group created in advance, an object group created by the user, and an automatically created object group. For example, when the object group includes a plurality of objects, the object group indicates the entirety of the plurality of objects. As an example, the object group is stored in the server 30 or the game terminal 10 in association with user identification information (for example, a user ID, a user name, or the like). Then, an object selected as an object to be used in the game processing among the plurality of objects is associated with the object group. For example, the object group is referred to in the game as a deck or team. Alternatively, the object group may be referred to as a group of articles, a group of organisms, a military force, a corps, a herd, or the like.

For example, an object is associated with an object group in a mode of being included in the object group. In addition, each object is visually recognized by object information displayed by the display apparatus. That is, the object information is displayed to allow the user to recognize the object. As an example, the object information is an object image or an icon image, a name of an object, an object ID, or the like. For example, when the object is a card, a card image, a card name, a card ID, and the like are the object information. Furthermore, the object information includes candidate object information indicating a candidate object, selected object information indicating a selected object, and change object information indicating a change object. Further, in the following description, when a specific example is given, a candidate object may be referred to as a candidate card, a selected object may be referred to as a selected card, and a change object may be referred to as a change card. Moreover, in the following description, an object may be referred to as a card, and an object group may be referred to as a deck.

As an example, the object group is configured to include a plurality of cards. Alternatively, an object may be associated with the object group in a mode that affects other objects or object groups. For example, an item object is equipped with a character object and associated with the object group in a mode that exerts an effect of increasing or decreasing a parameter of the character. As another example, a decorative object is associated with the object group by a mode that exerts an effect of decorating the appearance of the card as an object. In addition, a plurality of objects (for example, items or decorations) may be associated with one object (for example, a character). In this case, the plurality of objects may constitute one object group.

In at least a part of the game processing, the game progresses using the object associated with the object group. For example, the game progresses so that the object group to be used is automatically or manually created by the user. The creation of the object group includes a mode of creating a new object group and a mode of editing an existing object group. Specifically, the game progresses to use the objects of the object group to battle an object group of an opponent. The opponent is another user or a virtual opponent operated by a computer. In addition, the game may proceed so that a plurality of users having a cooperative relationship use objects of respective object groups to battle against the object group of the opponent.

The progress of the game using the object by the game processing may be another mode. For example, the other mode includes using an object to reinforce another object, and combining an object designated as a material with another object. Further, the other mode includes purchase, sale, disposal, exchange, receipt, transfer, lending, and borrowing of an object. Furthermore, an example in which the game is a battle type card game will be mainly described below. In the card game, a card is used as an example of the object, and a deck is created as an example of the object group. Moreover, as an example of the game processing, creation of a deck and a battle using the deck are executed.

As an example, the user battles an opponent user using a plurality of cards selected from the deck created by the user as hands. In the battle, one's turn and the opponent's turn are alternately repeated. Then, in the turn of the user, the user attacks the opponent with a card selected from the hands and decreases the points of the opponent. As a result, when the points of the opponent are lost, the user wins against the opponent. Further, the cards includes a monster card, a magic card, and a trap card. In each card, a card name, a card type, an attribute, a level, a race, a description, an effect, a usage, an attack power, a defense power, and the like are set.

### User Terminal

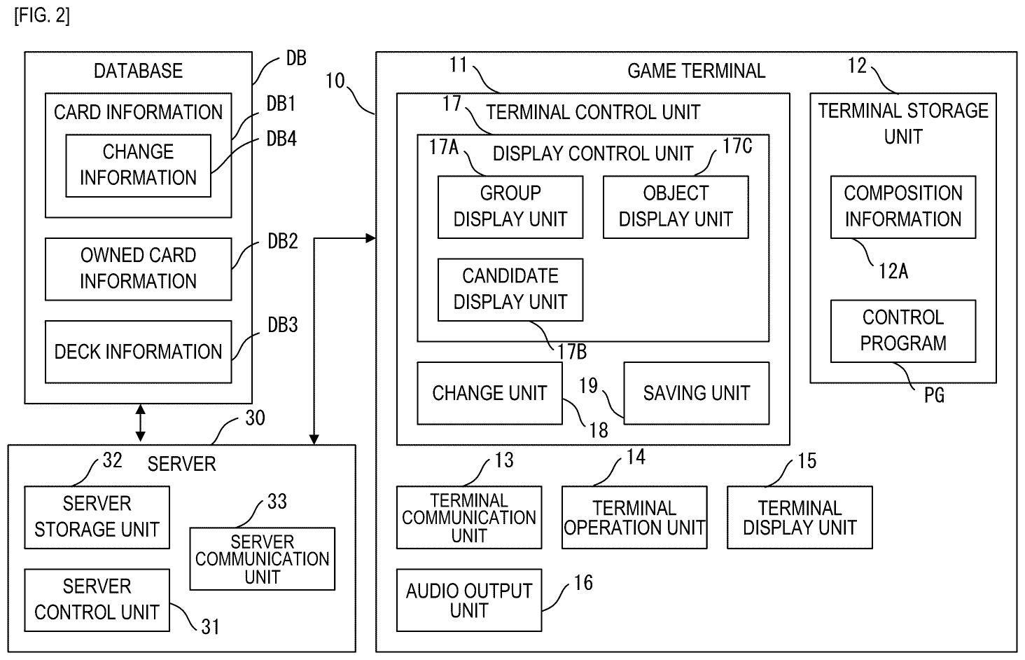

As illustrated in FIG. 2, the game terminal 10 includes a terminal control unit 11 as an example of a terminal control portion, a terminal storage unit 12 as an example of a terminal storage portion, a terminal communication unit 13 as an example of a terminal communication portion, a terminal operation unit 14 as an example of an operation portion, a terminal display unit 15 as an example of a display portion, and an audio output unit 16 as an example of an audio output portion. As an example, the terminal control unit 11 includes a processor (not illustrated). The processor is, for example, a central processing unit (CPU) or a micro-processing unit (MPU). Further, the processor controls the entire game terminal 10 based on a program stored in the terminal storage unit 12, and also controls various processes in an integrated manner.

The terminal storage unit 12 is a computer-readable non-transitory storage medium. Specifically, the terminal storage unit 12 includes random access memory (RAM) that is a system work memory for the processor to operate, and a storage apparatus such as a read only memory (ROM), a hard disc drive (HDD), and a solid state drive (SSD) that store a program and system software. In the present embodiment, the CPU of the terminal control unit 11 executes processing operations such as various calculations, controls, and determinations according to the control program PG stored in the ROM or the HDD of the terminal storage unit 12. Alternatively, the terminal control unit 11 can also perform control according to a control program stored in a portable recording medium such as a compact disc (CD), a digital versatile disc (DVD), a compact flash (CF) card, or a universal serial bus (USB) memory, or an external storage medium such as a server on the Internet.

Further, the terminal storage unit 12 stores a control program PG, which is an example of a game program, and composition information 12A. Moreover, the terminal storage unit 12 stores data (not illustrated) necessary for game processing of progressing a game such as a game image and game music. The control program PG causes the terminal control unit 11 as a computer to function as a display control unit 17, a change unit 18, a saving unit 19, a group display unit 17A, a candidate display unit 17B, and an object display unit 17C. That is, the terminal control unit 11 includes each unit as a logical device implemented by a combination of computer hardware and software. The control program PG can also be stored in another computer-readable non-transitory storage medium other than the terminal storage unit 12.

The composition information 12A is information related to the deck of the user who uses the game terminal 10. For example, the composition information 12A includes user identification information (for example, the user ID), a name of a character usable by the user, a deck ID, lock information indicating whether or not a composition is limited, detailed information regarding the content of the deck, and the like. As an example, the lock information indicates presence or absence of a lock that is changed by the user selecting a predetermined button on a deck content screen (not illustrated). Further, the detailed information is information regarding the deck, and includes the name of the deck as the deck identification information, the card identification information (for example, a combination of a card number and a serial number) of the card included in the deck, and the like. Furthermore, the card number is card identification information commonly set for cards having the same name. In addition, the serial number is card identification information set to be different from each other for each card.

Further, the composition information 12A includes the deck ID of the deck in the composition, information of owned cards related to cards owned by the user, deck content information related to the content of the deck in the composition, and display information related to display content on the terminal display unit 15. The owned card information includes a card number, the number of owned cards, a serial number, and the like. The candidate display unit 17B decides information to be displayed in a candidate display area 22 based on the information of the owned card. Therefore, the information of the owned card is used to display the candidate object information (for example, the card image of the candidate card) in the candidate display area 22. Furthermore, being owned means a state in which the user has acquired the card and is able to use the card. For example, in a state where the user owns a card, the card ID is stored in association with the user ID.

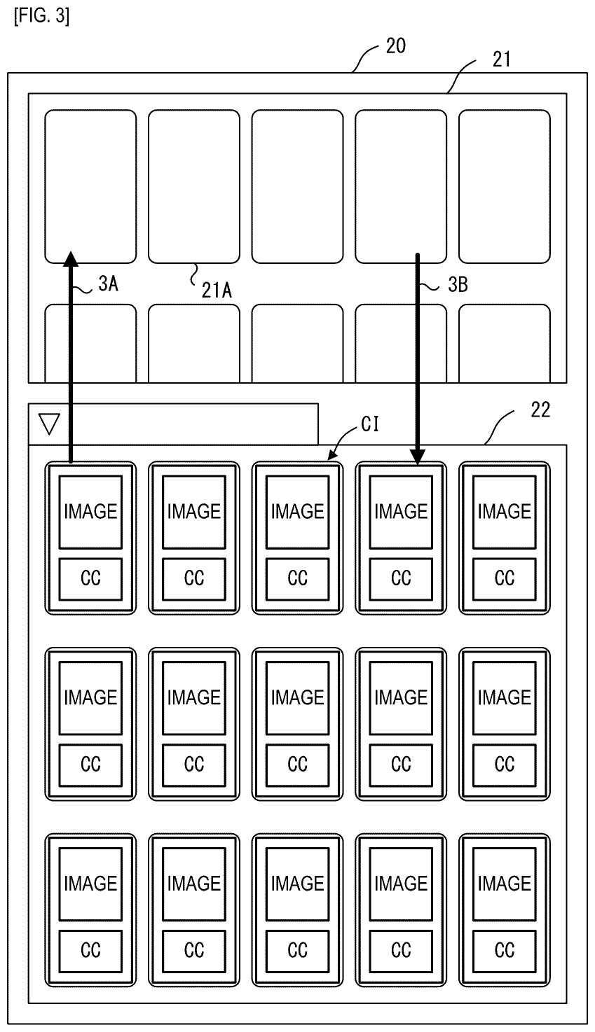

The deck content information is information for specifying a card incorporated in the deck being composed. For example, the deck content information includes a deck name, a card number, a serial number, and the like. On a composition screen 20 (FIG. 3), the deck name acquired with reference to the deck content information is displayed. Further, the group display unit 17A decides information to be displayed in a deck display area 21 of the composition screen 20 based on the deck content information. Thus, the deck content information is used to display the selected object information (for example, the card image of the selected card) in the deck display area 21.

The display information is information for causing a card to be displayed in the candidate display area 22 of the composition screen 20. For example, the display information includes an arrangement order of each card, a card number, a serial number, and the like. The object display unit 17C specifies an arrangement order of the change object information (for example, a card image of a change card) to be displayed in the candidate display area 22 based on the display information. In addition, the object display unit 17C causes the change object information indicating the specified change object to be displayed based on the display information. Similarly, the candidate display unit 17B specifies and causes an arrangement order of the candidate object information (for example, the card image of the candidate card) to be displayed based on the display information.

Furthermore, the terminal storage unit 12 stores information regarding the user in addition to the above-described information. The information regarding the user is, for example, user identification information, a game result, a user name, and the like. In addition, the terminal storage unit 12 may store information regarding the game terminal 10. The information regarding the game terminal 10 is, for example, identification information (for example, a terminal ID) for identifying each terminal. The terminal communication unit 13 is a communication module, a communication interface, or the like. Then, the terminal communication unit 13 enables transmission and reception of data between the server 30 and the game terminal 10 via the network 50.

The terminal operation unit 14 is an input system to which the user inputs a game operation. Further, the terminal display unit 15 is a device that displays a game screen (for example, the composition screen 20), and is, for example, a liquid crystal display, an organic EL display, or the like. The audio output unit 16 is an output device that outputs game music or the like, and is, for example, a speaker, a headphone, or the like. In FIG. 2, the terminal operation unit 14 and the terminal display unit 15 are illustrated separately. However, the terminal operation unit 14 and the terminal display unit 15 may be integrally configured as a touch panel. In addition, the terminal operation unit 14 may include a touch pad, a pointing device such as a mouse, a button, a key, a lever, a stick, or the like that is not integrated with the terminal display unit 15. In addition, the terminal operation unit 14 may be a device that detects a voice uttered by the user or a motion of the user and performs an operation according to a detection result.

For example, in the case of creating a deck, the user activates the game program and performs a predetermined operation from the terminal operation unit 14. As an example, the user performs an operation of causing a mode selection screen for selecting a composition mode of the deck to be displayed. In response to the operation, the terminal control unit 11 causes a mode selection screen (not illustrated) to be displayed on the terminal display unit 15. On the mode selection screen, the user can select to cause a deck selection screen (not illustrated) for selecting a deck to be subjected to content confirmation or composition to be displayed. Moreover, on the mode selection screen, the user can select to cause an owned card screen (not illustrated) for displaying cards owned by the user or an electronic bulletin board (not illustrated) for sharing information regarding a game to be displayed.

Next, when the user performs an operation of displaying the deck selection screen, the terminal control unit 11 causes the deck selection screen to be displayed on the terminal display unit 15. As an example, there is a plurality of characters in a game, and the user can select and compose a deck of each character. One deck may be set for each character, or a plurality of decks may be set for each character. Moreover, the user may be able to add or remove the deck of each character. On the deck selection screen, the user can select one of the decks of one of the characters. Alternatively, the deck does not need to correspond to a character. For example, the user may be able to set and use the deck composed by the user, regardless of the character.

When the user performs an operation of selecting a deck, the terminal control unit 11 causes the composition screen 20 of FIG. 3 to be displayed on the terminal display unit 15 in order to compose the deck. As an example, the deck display area 21 is provided on the composition screen 20. As an example of the object information, a plurality of card images CI imitating the appearance of a front side of a card included in the deck is displayed in the deck display area 21. Further, although not illustrated, a card image CI includes an image of a character, a magic, a trap, an item, or the like corresponding to the card, decorations of the card, parameters such as attack power and defense power, effects of the card, a level of the card, and other information such as rarity of the card.

Furthermore, the example of FIG. 3 illustrates a state in which the deck is not created. Thus, the card image CI is not displayed in the deck display area 21. On the other hand, when an already created deck is composed, the card image CI indicating a card included in the deck to be composed is displayed in the deck display area 21. In the deck display area 21, the cards included in the deck are displayed in a predetermined order (for example, in order of acquisition time, in order of rarity, in order of level, in order of type of card, in order of attack power, or in order of defense power and the like). Further, on the composition screen 20, the card image CI outside the screen can be displayed by scrolling or screen shifting in the deck display area 21 and the candidate display area 22. Thus, the card images CI of more cards than the number illustrated in FIG. 3 can be displayed on the composition screen 20. However, when the composition screen 20 has a sufficient size, all the card images CI may be displayed in the same screen. That is, all the card images CI may be displayed so as to be visually recognizable without performing an operation such as scrolling or screen transition. For example, the deck display area 21 may be configured not to scroll when the number of cards forming a deck is small.

In addition, the composition is a process of changing information related to the deck, and includes, for example, a process of addition, exclusion, or changing of cards included in the deck, a process of changing the name of the deck, and the like. For example, when a card is included in the deck, the user can use the included card during the game. The addition is a process of associating the card identification information with the deck identification information. For example, in the process, a state of a card not being included in the deck is changed to a state of being included in the deck. Thus, the card is incorporated into the deck, and the card is included in a part of the deck. Further, the exclusion is a process of cancelling the state in which the card identification information and the deck identification information are associated with each other. For example, in the process, a state of a card being included in the deck is changed to a state of not being included in the deck. Accordingly, the card is removed from the deck, and the card is excluded from the deck.

As an example, the number of cards included in the deck is equal to or more than 20 and equal to or less than 30, and a maximum of 35 cards can be displayed in the deck display area 21. Alternatively, the number of cards included in the deck may be any number. For example, the number of cards may be equal to or more than 31 or equal to or less than 19, or may be equal to or more than two and equal to or less than five, or equal to or more than 20 and equal to or less than 50. In addition, there may be no upper limit on the number of cards included in the deck. In addition, the number of cards included in the deck may be limited for cards identified by the same card identification information. For example, the number of the cards enabled to include in the deck may be limited to one, or may be limited to a predetermined number (for example, two or three). Alternatively, the number of cards enabled to include in the deck may be limited to any number of four or more, or to the number set by the user.

The composition screen 20 may be provided with an information display area for causing various information related to the deck to be displayed. For example, the information display area displays the name of the deck, the number of cards included in the deck, the content of the skill set for the character, and the like. Further, in the information display area, the number of cards for each type of cards included in the deck is displayed. In addition, the composition screen 20 may be provided with a detailed information display area for causing detailed information of the card selected by the user to be displayed. The user can select a card by a predetermined operation. For example, the predetermined operation includes click, double click, button depression, tap, double tap, long tap, drag, flick, swipe, pinch, and the like.

In addition, the composition screen 20 may be provided with a chat display area in which content of a chat between users is displayed. A button to display the content of a chat is displayed in the chat display area, and the user can select the button. Thus, a display state in which the content of a chat is displayed in the chat display area and a non-display state in which the content is not displayed are switched. In addition, the composition screen 20 may be provided with an input field for inputting a name to be set to the deck. Moreover, the composition screen 20 may be provided with a selection field for selecting a skill to be set on a character who is the user of the deck in the game.

Moreover, the composition screen 20 may be provided with a button to exclude all the cards included in the deck, a button to open a setting menu related to the deck composition, and a button to automatically create the deck. In addition, the composition screen 20 may be provided with a button to change the display format of the card and an area for displaying the content (for example, parameters) of the selected card. Further, a button to hide the card image CI of the selected card and a button to display the card image CI of a card related to the selected card may be provided on the composition screen 20.

In addition, the composition screen 20 may be provided with a save button (not illustrated) for confirming and saving the content of the deck. Alternatively, the content of the deck may be confirmed and saved every time each card is added to or removed from the deck. Further, the content of the deck may be confirmed and saved when transitioning from the composition screen 20 to another screen. Moreover, the composition screen 20 may be provided with a return button to the previous screen, a return button to the top screen, and a button to hide a part of an area (for example, the candidate display area 22). Incidentally, the areas, buttons, and the like described as examples to be displayed on the composition screen 20 may be displayed on a pop-up screen different from the composition screen 20, or on another screen displayed by transitioning from the composition screen 20.

In at least one of the deck display area 21 or the candidate display area 22, a plurality of pieces of object information identified by the same object identification information may be displayed so as to be distinguished from each other. For example, a plurality of card images CI having the same card name may be displayed side by side. In addition, only one piece of object information identified by the same object identification information may be displayed in at least one of the deck display area 21 or the candidate display area 22. For example, one card image CI may be displayed for a plurality of cards having the same card name. In this case, the number of cards owned by the user may be additionally displayed in one card image CI.

### Terminal Control Portion

Returning to FIG. 2, the terminal control unit 11 of the game terminal 10 includes the display control unit 17 which is an example of a display control device, the change unit 18 which is an example of a change portion, and the saving unit 19 which is an example of a saving portion. Moreover, the display control unit 17 includes the group display unit 17A which is an example of a group display portion, the candidate display unit 17B which is an example of a candidate display portion, and the object display unit 17C which is an example of an object display portion.

### Group Display Portion

The group display unit 17A causes the selected object information indicating the selected object associated with the object group to be displayed on the screen. That is, the group display unit 17A causes information indicating an object associated with the object group to be displayed on the composition screen 20 by the terminal display unit 15. As an example, the deck includes the selected card selected by the user. In this case, the group display unit 17A causes the card image CI to be displayed in the deck display area 21 of the composition screen 20 as the selected object information indicating the selected card.

In other words, the group display unit 17A causes information indicating each of the plurality of cards included in the deck to be displayed in the deck display area 21. Thus, the user can recognize the content of the deck. For example, the selected object information is information displayed for the user to recognize the selected object. As an example, the selected object information is a card name or a card ID of a card included in the deck, and is expressed by a combination of characters, symbols, and the like.

In addition, the group display unit 17A may cause card names or card IDs to be displayed in a list form. Moreover, the group display unit 17A may cause the card image, the card name, the card ID, and the like to be displayed in a predetermined order in the list. In addition, the group display unit 17A may cause a name indicating the card to be displayed as the selected object information in an upper part of the card image CI. Furthermore, data for causing the selected object information to be displayed is stored in the server storage unit 32 or the terminal storage unit 12, and the group display unit 17A causes the selected object information to be displayed based on the data.

In addition, the group display unit 17A may cause the selected object information to be displayed in the candidate display area 22 in a different mode from that of another candidate object. Moreover, the group display unit 17A may cause the selected object information to be displayed in a plurality of areas at different positions in the screen. As an example, in addition to the deck display area 21, the group display unit 17A may also cause the selected object information to be displayed in an area for displaying information indicating cards excluded from the deck or added to the deck. This area is located at a position different from the deck display area 21. However, a part of the area may overlap a part of the deck display area 21. In addition, the area may be located closer to an end of the screen than the deck display area 21, or may be smaller in area than the deck display area 21. In addition, the area may be outside the screen and move into the screen by a swipe operation or the like of the user. Moreover, the area in the screen may be moved to the outside of the screen by the swipe operation or the like of the user. In other words, the area may be configured to be movable by a user's operation from the outside of the screen to the inside of the screen or from the inside of the screen to the outside of the screen.

### Candidate Display Portion

The candidate display unit 17B causes candidate object information indicating candidate objects to be associated with the object group to be displayed on the screen. The candidate object information is information indicating a candidate object that can be associated with an object group among a plurality of objects. The candidate object information is used to cause the user to recognize the candidate object. For example, the candidate object information is the card image of the candidate card, or the like.

For example, the candidate display unit 17B causes the candidate object information to be displayed in the candidate display area 22 of the screen. In the example of FIG. 3, the candidate display area 22 is provided on the composition screen 20. The candidate display unit 17B causes the card image CI indicating each candidate card CC to be displayed in the candidate display area 22 as an example of the candidate object information that can be associated with the deck selected by the user. Each of the candidate cards CC is an object that can be used by the user to compose or create the deck, and is a card mainly owned by the user.

However, the candidate card CC may include a card not owned by the user, such as a card owned by another user or a card lent or transferred to the user. Alternatively, the candidate display unit 17B may cause a card that cannot be used for the composition or creation of the deck in the candidate display area 22 to be displayed in a different mode from that of another candidate card CC. The unusable card is, for example, a card restricted from being included in the deck or a card having reached the upper limit of the number of cards to be included in the deck. Even these cards are candidates to be included in the deck by satisfying the condition (for example, the upper limit is set to be increased).

Further, the candidate display unit 17B may cause the candidate object to be displayed in addition to or separately from the candidate display area 22. For example, the candidate display unit 17B causes a card owned by the user to be displayed as a candidate object in the candidate display area 22. Moreover, the candidate display unit 17B causes a card that is not owned by the user and can be acquired to be displayed as a candidate object on a card acquisition screen (not illustrated). The user can add the card acquired on the acquisition screen to the deck. In addition, the candidate display unit 17B may also cause the candidate object to be displayed in the deck display area 21 in addition to the candidate display area 22. The user can select a card displayed in the deck display area 21 and included in the deck to add the same card to the deck or exclude the card from the deck. Furthermore, candidate objects displayed outside the candidate display area 22 are also a target of change processing by the change unit 18.

In addition, the candidate display unit 17B may cause the candidate card information to be displayed in a list form on a screen on which a deck card list indicating cards included in the deck is displayed. In this case, the addition of a card by the user may be an operation of moving the candidate card information (for example, the card image CI) displayed in a list form to the deck card list. In addition, the exclusion of a card by the user may be an operation of moving the candidate card information from the deck card list to an area where the candidate card information is displayed in a list form. Moreover, the candidate display unit 17B may cause only the candidate card information indicating a card that is owned by the user and is not included in the deck to be displayed. In addition, the candidate display unit 17B may cause only the candidate card information indicating a card not owned by the user to be displayed. In addition, the candidate display unit 17B may cause only the candidate card information indicating a card not included in the deck to be displayed.

### Change Portion

The change unit 18 performs change processing including at least one of selection change or cancellation change. Then, the change unit 18 associates a selected object selected from candidate objects with the object group as selection change processing. In addition, the change unit 18 cancels the association between the selected object and the object group as cancellation change processing. Specifically, the selection change includes processing of adding the selected object to the object group. In addition, the cancellation change includes processing of excluding the selected object included in the object group from the object group.

An example of the change processing will be described with reference to FIG. 3. When the user selects the composition mode, the display control unit 17 causes the composition screen 20 to be displayed. On the composition screen 20, the deck display area 21 at an upper part of the screen and the candidate display area 22 at a lower part of the screen are simultaneously displayed. Alternatively, the deck display area 21 and the candidate display area 22 may be displayed side by side on the left and right on the composition screen 20. Then, addition and deletion of a card is executed by an operation of moving the card image CI from one of the deck display area 21 and the candidate display area 22 to the other. Moreover, the operation of moving the card image CI may be a flick, a swipe, a right click, a left click, an operation of selecting a card and selecting an add button or an exclude button, an operation of selecting a button, or the like. In addition, the movement, selection, addition, or exclusion of the card may be performed by a voice input of the user.

Specifically, when it is desired to add a card to the deck, the user selects the candidate card CC in the candidate display area 22 by a click operation, a long tap, or the like via the terminal operation unit 14. Then, the card image CI of the selected card is dragged in the direction indicated by an arrow 3A and dropped on one of empty frames 21A in the deck display area 21. The card image CI is not displayed in the empty frame 21A. Thus, the change unit 18 executes selection change processing and causes the card ID of the selected card to be stored in the terminal storage unit 12, the server storage unit 32, or the like in association with the deck ID of the deck. Incidentally, a card may be added if the user drops the card image CI in the deck display area 21 without dropping the card image CI in the frame 21A. As an example, the additional card in this case is displayed in any of the empty frames 21A (for example, according to a mode to be shifted to the left). Moreover, in another screen for displaying the content of the card, the card may be added by the user selecting an add button.

Then, the group display unit 17A causes, for example, the card image CI to be displayed in the deck display area 21 as information indicating the selected card. At this time, the group display unit 17A causes the card image CI to be displayed by arranging in the order of addition from the upper left to the right or downward. Alternatively, the group display unit 17A may cause the card image CI to be displayed on the frame 21A on which the card image CI is dropped. In addition, the number of frames 21A corresponds to the number of cards that can be incorporated into the deck. Thus, the user can visually recognize the number of cards that can be assembled into the deck. Moreover, the number of cards added to the deck may be displayed in each frame 21A. For example, “1” is displayed in the upper left frame 21A, and “2” is displayed in the frame 21A right adjacent thereto. Accordingly, the user can visually recognize how many cards are added to or deleted from the deck.

When it is desired to exclude a card from the deck, the user selects a card (not illustrated) in the deck display area 21 by a click operation, a long tap, or the like via the terminal operation unit 14. Then, the card image CI of the selected card is dragged in the direction indicated by an arrow 3B and dropped in the candidate display area 22. Thus, the change unit 18 executes the cancellation change processing and cancels the association between the card ID of the selected card and the deck ID of the deck. Then, the group display unit 17A changes the card image CI indicating the deleted selected card to non-display in the deck display area 21. Moreover, in another screen for displaying the content of the card, the card may be excluded by the user selecting an exclude button.

For example, the change unit 18 performs selection change processing of adding a card to the deck as follows. That is, the change unit 18 updates at least one of deck information DB3 of the database DB or the composition information 12A of the terminal storage unit 12 so as to associate the deck ID with the card number and the serial number of the selected card. As an example, the change unit 18 performs association by storing information in the same record. Further, for example, the change unit 18 performs cancellation change processing of excluding the card from the deck as follows. That is, the change unit 18 updates at least one of the deck information DB3 or the composition information 12A so that the association between the deck ID and the card number and the serial number of the selected card is canceled. As an example, the change unit 18 cancels the association by setting a state in which information is not stored in the same record. Specifically, the change unit 18 erases the card number and the serial number associated with the deck ID.

The addition of the card to the deck, that is, the association between the card ID and the deck ID can be performed when movement of the card image CI is completed. For example, when the card image CI of the selected card is moved from the deck display area 21 to the candidate display area 22, the group display unit 17A causes the card image CI to be displayed in the frame 21A of the deck display area 21. Thus, the selected card is added to the deck, and the change unit 18 causes the card ID to be stored in the terminal storage unit 12 or the server storage unit 32 in association with the deck ID. Moreover, the change unit 18 causes the card ID of the moved selected card to be stored in the terminal storage unit 12 or the server storage unit 32 in association with the identification information of the frame 21A. As an example, the identification information of each frame 21A includes a frame number, a frame ID, and the like. Alternatively, when the candidate object is selected, the change unit 18 may add the candidate object. For example, when the user clicks the card image CI indicating the candidate card, the change unit 18 adds the card to the deck.

The card can be excluded from the deck, that is, the association between the card ID and the deck ID can be canceled when the movement of the card image CI is completed. For example, when the card image CI is moved from the candidate display area 22 to the deck display area 21, the group display unit 17A changes the card image CI displayed in the deck display area 21 to non-display. Thus, the card is excluded from the deck, and the change unit 18 deletes the card ID associated with the deck ID. Moreover, the change unit 18 deletes the card ID associated with the identification information of the frame 21A. Alternatively, when the selected object is selected, the change unit 18 may exclude the selected object. For example, when the user clicks the card image CI indicating the selected card included in the deck, the change unit 18 excludes the card from the deck.

Further, at least one of the addition of the card to the deck and the exclusion of the card from the deck may be confirmed by another operation by the user. For example, in a state where the user moves the card image CI, addition, deletion, or the like may not be performed, and the addition, deletion, or the like may be executed by an operation of selecting a save button (not illustrated). At this time, a standby state of addition or deletion is set until an operation of selecting the save button is performed. Moreover, the user may move the card image CI and replace the card image CI by superimposing the card image CI on the card image CI included in the deck. In this case, the change unit 18 may simultaneously process the addition of the card and the exclusion of the card, or may process either of them first.

Further, the selection of the selected object includes manual selection performed by the user and automatic selection performed by the computer (for example, the terminal control unit 11 or the server control unit 31). For example, the automatic selection is processing in which a computer selects a card based on a predetermined rule even if the user does not select the card. In other words, the automatic selection is a process of selecting at least one card by a computer executing a program in which a predetermined rule is described. As an example, the user selects an automatic composition button displayed on the composition screen 20. Thus, the deck is automatically composed, so that the burden on the user can be reduced. In addition, the terminal control unit 11 or the server control unit 31 may automatically select a recommended card for a user who does not know a card to be added or excluded. This recommended card may be automatically added to the deck, or may be displayed on the terminal display unit 15.

Further, the deck that is automatically composed includes a card owned by the user. Moreover, a card not owned by the user may be included in the deck to be automatically composed. In this case, the user can hold the card by purchasing the card or winning the card by lottery, and cannot use the deck until the user holds the card. Moreover, the user can add or exclude a card on the composition screen 20 with respect to the automatically composed deck. In addition, the card may be automatically added or excluded by the terminal control unit 11 or the server control unit 31.

Further, the change processing may include selection change processing of providing the card included in the deck with an equipment card and cancellation change processing of removing equipment of the equipment card. In this case, the equipment card may not be included in the deck and the parameters of the card may be increased or decreased. In addition, the change processing may include selection change processing of setting a skill card for the character and cancellation change processing of removing the set of the skill card. In this case, the skill card may not be included in the deck and the content of the effect of the character may be changed.

### Saving Portion

The saving unit 19 stores the change information indicating that the change processing has been performed in association with the object identification information for identifying the change object. The change information is information indicating that the change processing has been performed, and may be information indicating presence or absence of a change. In addition, the saving unit 19 stores the change information in at least one of the terminal storage unit 12, the server storage unit 32, or the database DB. Hereinafter, an example in which the saving unit 19 stores change information DB4 in the database DB will be mainly described. Furthermore, in the example illustrated in FIG. 2, the database DB stores card information DB1, owned card information DB2, and the deck information DB3. The change information DB4 is included in the owned card information DB2.

As an example, the card information DB1 illustrated in FIG. 2 is a database of information regarding cards. For example, the card information DB1 includes a card number which is an example of the card identification information, detailed information of a card associated with a card ID, and the like. The detailed information of the card is information related to the card, and includes, for example, a name, a type, a level, rarity, an attribute, a race, an attack power, a defense power, an effect description, monster information, and the like. In addition, the detailed information of the card may include identification information for identifying each card image. Further, the owned card information DB2 illustrated in FIG. 2 is a database of information regarding cards owned by each user. For example, the owned card information DB2 includes the user ID, the card number of a card owned by the user, the number of owned cards, the serial number of the card, and the like.

Further, the deck information DB3 is a database of information regarding the deck of each user. For example, the deck information DB3 includes user identification information, the name of a character that can be used by the user, the deck ID, the lock information indicating whether or not a content change of the deck is restricted, detailed information of the deck related to the content of the deck, and the like. As an example, the lock information indicates presence or absence of the lock, and is changed by the user selecting a predetermined button on the deck content screen. Further, the detailed information of the deck is information related to the deck, and includes the name of the deck for identifying the deck, the card identification information (for example, a combination of the card number and the serial number) of a card included in the deck, and the like.

The saving unit 19 may save the change information DB4 for a predetermined period. As an example, the predetermined period is a period from the start of display of the composition screen 20 to the end of display, or a period from the start of display of the composition screen 20 to the confirmation of the deck. For example, the user can select a save button to confirm the deck. Alternatively, the predetermined period is 24 hours, 48 hours, 72 hours, one week, one month, one year, or the like. Specifically, when the predetermined period is 24 hours, the saving unit 19 saves the change information DB4 of the change processing performed up to 24 hours before the time of saving. Then, when 24 hours have elapsed from the change processing, the saving unit 19 deletes the change information DB4 corresponding to the change processing. Incidentally, the saving unit 19 may save the change information DB4 in the form of a ring buffer every predetermined period (for example, one day, one hour, one week, or the like). In this case, the object display unit 17C may cause the change object information indicating the change object included in the most recently overwritten change information DB4 to be displayed in a different manner. In addition, the predetermined period may be settable by the user.

As an example, the saving unit 19 saves the change timing at which the change processing has been performed as the change information DB4. For example, the change timing indicates a time point when the user performs an operation of selecting, adding, or deleting a card, or a time point when the user confirms processing corresponding to these operations. Then, when the change timing associated with the card ID is saved, the change timing indicates that the card identified by the card ID has become the target of the change processing. For example, the change timing is the date and time when the change processing is performed based on the built-in clock of the server 30 or the game terminal 10. The change timing can be expressed by year, month, day, and time.

By saving the change timing, the object display unit 17C can refer to the change information DB4. Then, the object display unit 17C can arrange the change object information based on the change timing. For example, the object display unit 17C can arrange the change object information in the order of early or late change timing. Thus, it is possible to reduce time and effort for searching among a large number of candidate objects, so that a burden on the user when the object group is created is reduced. Alternatively, the change timing may be represented by an elapsed time from the composition start, the display start of the composition screen 20, or the game start. Moreover, the change timing may be represented by a virtual time in the game.

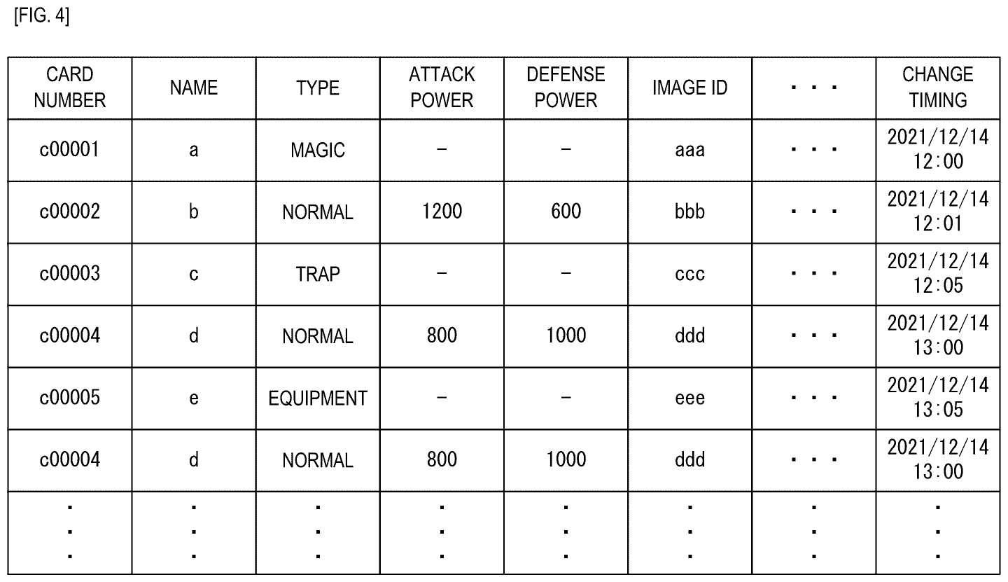

Specifically, FIG. 4 illustrates a data storage example of the change information DB4 in the card information DB1. The card information DB1 is a database related to cards. For example, the card information DB1 includes the card number, which is card identification information, detailed information of the card, and the like. Moreover, the card information DB1 includes the change timing, which is an example of the change information DB4, in a state of being associated with the card number. Then, the saving unit 19 overwrites and saves the card information DB1 so as to include the change timing associated with the card number. Alternatively, the change information DB4 may be included in a database different from the card information DB1 as long as the object identification information is associated with the change information DB4. For example, the terminal storage unit 12 or the server storage unit 32 may store the change information DB4 associated with the card ID.

As a specific example, the user moves the card image CI of the candidate card CC illustrated in FIG. 3 from the candidate display area 22 to the deck display area 21. Then, the saving unit 19 saves the date and time when the card identification information and the deck identification information are associated with each other using the candidate card CC as the selected card as the change timing. This change timing is the date and time when the change processing such as addition or exclusion of the card is completed, and indicates the execution date and time of the drop operation. However, the change timing may be a timing when the composition of the deck is completed, and the like.

In this manner, the saving unit 19 adds the date and time indicating an addition timing to the card information DB1 when the card is added to the deck. Further, when the card is excluded from the deck, the saving unit 19 adds date and time indicating an exclusion timing to the card information DB1. Moreover, when the date and time of the addition timing and the exclusion timing have already been added, the saving unit 19 overwrites and saves the date and time with date and time indicating subsequent addition timing or exclusion timing. Thus, the date and time of the last change is recorded for each card. Furthermore, there is no change timing for cards that have not been added to or excluded from the deck. However, the saving unit 19 may save the date and time indicating an acquisition timing of the card instead of the change information DB4. Even when the acquisition timing is saved, the saving unit 19 overwrites and saves the acquisition timing by the date and time indicating the subsequent addition timing or exclusion timing.

Further, depending on the game, the user may have a plurality of objects identified by the same object identification information. For example, the user may hold a plurality of cards having the same name. In this case, each of the plurality of same objects may be identified by additional identification information in addition to the common object identification information. For example, a branch number ID may be added to the card ID so that each of a plurality of the same cards can be distinguished. In particular, in the case of a game in which a parameter of an object (for example, a character) changes by raising, it is necessary to identify the object for each user and each card. Even in this case, each card can be identified by creating information in which the branch number ID is added to the card ID. Incidentally, even in a game in which each user can hold only one same card, identification information unique to each card may be created. Instead of the card ID, the branch number ID may be added to the card number, the card name, an image ID, or the like.

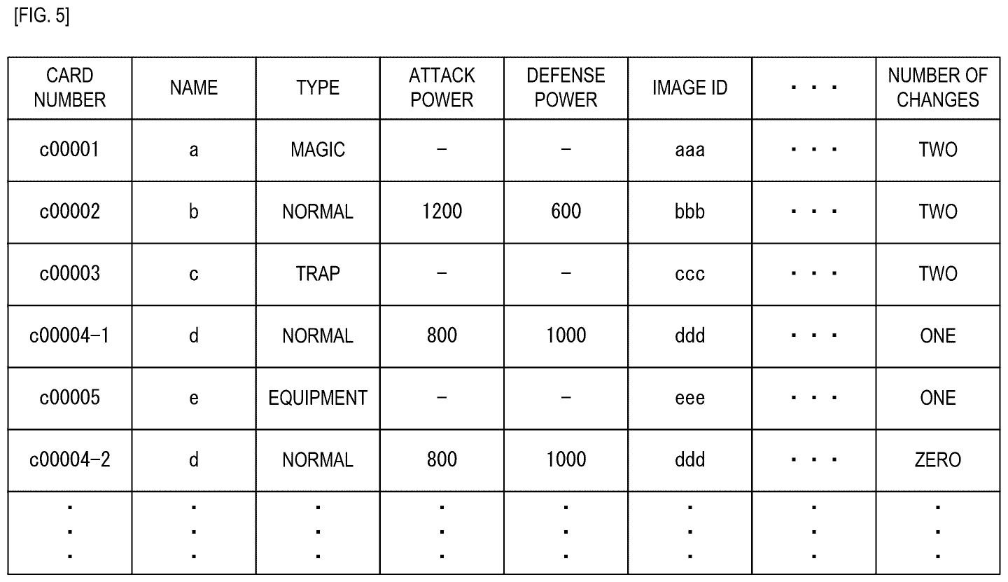

For example, in the data storage example illustrated in FIG. 5, the branch number is added to the card number. Specifically, there are two cards identified by the card number “c00004”. Thus, the card number of one card is saved as the card number “c00004-1” to which the branch number “1” is added so that the cards can be distinguished from each other. Further, the branch number “2” is added to the card number of the other card, and the other card is saved as the card number “c00004-2”. Thus, in the game system 100, each of the plurality of same cards is distinguished.

Further, as another example, the saving unit 19 saves the number of changes for which the change processing has been performed as the change information DB4. Thus, the object display unit 17C can arrange the change object information based on the number of changes with reference to the change information DB4. For example, the object display unit 17C can arrange the change object information in descending order or ascending order of the number of changes. Thus, it is possible to reduce time and effort for searching among a large number of candidate objects, so that a burden on the user when the object group is created is reduced.

When the number of changes associated with the card ID is saved, the number of changes indicates that the card identified by the card ID has become the target of the change processing. As an example, in the data storage example illustrated in FIG. 5, the card number and the detailed information of the card are stored in the card information DB1. Moreover, in the card information DB1, the number of changes, which is an example of the change information DB4, is included in association with the card number. That is, the saving unit 19 overwrites and saves the card information DB1 so as to include the number of changes associated with the card number. Furthermore, the number of changes as an example is the number of times of becoming the target of the change processing during a predetermined period (for example, 24 hours or the like going back from the display time point). Alternatively, the number of changes may be the number of times of becoming the target of the change processing in the past, that is, during the entire period from the start of the game by the user.

In addition, the saving unit 19 may save the change information DB4 so that the change information DB4 of the change processing previously performed on at least one change object is replaced with the change information DB4 of the change processing later performed on the at least one change object. That is, when there is a plurality of object groups, the change unit 18 performs change processing on each of the plurality of object groups. Then, the saving unit 19 saves the change information DB4 for each object group, or saves the change information DB4 common to a plurality of object groups. For example, a plurality of decks may be associated with one character. Alternatively, one deck may be associated with each of the plurality of characters. In this case, there is a plurality of decks, that is, object groups, which can be set as use targets in the game. As an example, the plurality of decks is independent from each other, and the user can select a card to be associated with each deck.

Specifically, when one deck is selected and used in one play (for example, one battle, quest, or the like), the user composes the selected deck. When there is a plurality of decks, the user may include a card identified by the same card ID in the plurality of decks. Then, the card may be added or excluded a plurality of times for different decks. In this case, the change unit 18 performs change processing on each deck. Then, the saving unit 19 saves the change information DB4 for each object group, or stores the change information DB4 common to a plurality of object groups.

In particular, when the common change information DB4 is saved, the saving unit 19 saves the change information DB4 of the last change processing in the change information DB4 common to the plurality of object groups. For example, the saving unit 19 overwrites and saves with the last added or excluded change timing in association with the card ID. Thus, when there is a plurality of object groups, the common change information DB4 is overwritten and saved. Thus, the preference of the user through all the object groups can be reflected in the change information DB4. That is, the object that has been the target of the change processing by the user can be specified via the change information DB4 through all the object groups. Then, by displaying the information indicating the object, the preference of the user can be displayed based on the entire game. In addition, the user can easily find the change object that has been the target of the change processing in another object group.

On the other hand, when the change information DB4 is saved for each object group, an object that has been the target of the change processing by the user can be specified for each object group via the change information DB4. Then, by displaying the information indicating the object, the preference of the user can be displayed based on each object group. Incidentally, the saving unit 19 may save the change information DB4 for each object group and save the change information DB4 common to a plurality of object groups. Thus, the change information DB4 can be selectively used by the object display unit 17C. For example, the object display unit 17C can use the change information DB4 saved for each deck when an existing deck is selected and composed, and can use the common change information DB4 when a new deck is composed.

### Object Display Portion

The object display unit 17C refers to the change information DB4 and causes the change object information indicating the change object that has become the target of the change processing to be displayed in a different mode from that of the candidate object information indicating the candidate object. For example, the change object information is an object image or an icon image, an object name, an object ID, or the like. As an example, the object display unit 17C causes the change object information to be displayed on the terminal display unit 15. Moreover, the object display unit 17C causes the change object to be displayed in a different mode from that of the candidate object information in order to make it easier for the user to specify the change object.

For example, the different mode is highlight display or weak display of the object information. Further, the different mode includes a mode in which at least one of a display position, a size, a shape, a color, brightness, saturation, density, a font, luminance, transparency, an effect such as blinking or rotation, presence or absence of graying out, and the like is made different. Moreover, the different mode may include a mode in which a character or an image is made different by being added or deleted. In addition, the different mode may be a different mode by pop-up display of the object information or the like. Furthermore, the different mode is a mode that can be distinguished from a display mode in which an object is selected or temporarily selected. For example, the different mode is a mode that can be distinguished from the selected card in a state where the user selects the card.

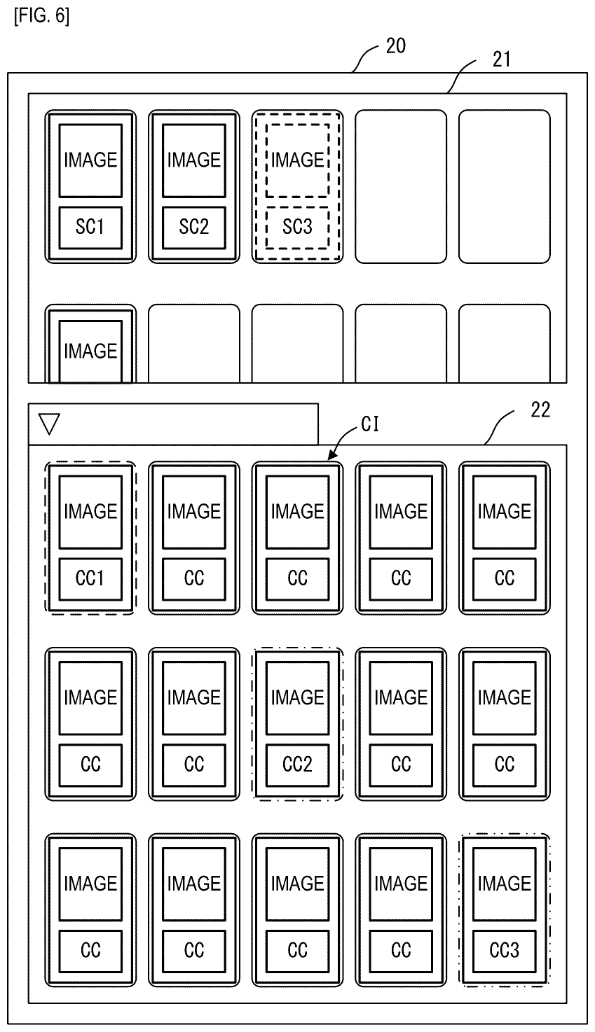

Specifically, referring to the composition screen 20 illustrated in FIG. 6, the change card CC1 is added to the deck as the change object from among the plurality of candidate cards CC which are the candidate objects. Then, the group display unit 17A causes the card image CI indicating the selected card SC1, which is the selected object, to be displayed in the deck display area 21. That is, the change card CC1 and the selected card SC1 are the same card. Then, the object display unit 17C causes the card image CI as the change object information indicating the change card CC1 to be displayed in a different mode from that of the card image CI indicating other candidate cards CC. In the example of FIG. 6, the object display unit 17C causes the card image CI indicating the change card CC1 and surrounded by a broken line in the candidate display area 22 to be displayed in a mode surrounded by an orange frame line, for example. On the other hand, the candidate display unit 17B does not add the frame line to the card image CI indicating another candidate card CC. Thus, the object display unit 17C varies the display mode depending on presence or absence of the frame line and the color of the frame line.

Similarly, the change card CC2 is added to the deck, and the group display unit 17A causes the card image CI indicating the selected card SC2 to be displayed in the deck display area 21. Moreover, the selected card SC3 is excluded from the deck, and the group display unit 17A causes the card image CI indicating the selected card SC3 to be non-displayed in the deck display area 21. Furthermore, in FIG. 6, the card image CI indicating the selected card SC3 that is not displayed is indicated by a broken line for convenience.

When the change processing thereof is performed, the object display unit 17C refers to the change information DB4. Then, the object display unit 17C differs the display modes of the card images CI indicating the change card CC2 corresponding to the selected card SC2 and the change card CC3 corresponding to the selected card SC3. Specifically, in the example of FIG. 6, the object display unit 17C causes the card image CI indicating the change card CC2 and surrounded by a one-dot chain line to be displayed in a mode surrounded by a yellow frame line. Then, the object display unit 17C causes the card image CI indicating the change card CC3 and surrounded by a two-dot chain line to be displayed in a mode surrounded by a blue frame line. In this manner, the object display unit 17C makes the display in different mode from that of the card image CI indicating another candidate card CC.

In addition, the object display unit 17C may cause the change object information to be displayed in the different mode by causing the change object information to be displayed at a position above the candidate object information on the composition screen 20. Thus, the change object information is easily displayed on the composition screen 20 without scrolling. Thus, the user can more easily recognize the change object even when the composition screen 20 is small. Alternatively, the object display unit 17C may cause the change object information to be displayed at a position lower than the candidate object information. In addition, the object display unit 17C may cause the change object information to be displayed in a list form.

By differing the display mode, the user can easily recognize the object that has become the target of the change processing, for example, the card added to the deck or excluded from the deck. Thus, if the user reconsiders that the card added to the deck is unnecessary during one composition operation, the card can be easily specified and excluded from the deck. Further, if the user reconsiders that the card deleted from the deck is necessary during one composition operation, the card can be easily specified and added to the deck. This can reduce the burden on the user when the object group is created.

In particular, in a game played using objects, a user creates in advance an object group including a predetermined number of objects as a set from among the objects owned by the user. Then, when playing the game, the user decides an object to be used from the selected object group. However, when the number of objects owned by the user increases, it is difficult to find a desired object. Moreover, in composing object groups, the user often performs trial and error, and addition and removal of the same object may be repeated.

For example, the user may remove the card from the deck after adding the card to the deck. In addition, after the user excludes a certain card from the deck, the card may be added to the deck. In such a case, the work of causing the user to find a desired object is inefficient. Moreover, this work also causes stress on the user. In order to reduce the burden, a function of arranging the candidate cards according to a predetermined order (for example, in descending order or ascending order of levels), a search function using the card name or the character name, or the like can be provided. Alternatively, it is also possible to provide a function of narrowing down and displaying cards corresponding to a predetermined condition (for example, attribute) and the like.

However, searching for cards added to or excluded from the deck during the composition of the deck is a burden on the user even if the above function is used. Therefore, the object display unit 17C causes the change object information to be displayed. Accordingly, the user can easily find a desired card and easily add the card to the deck or delete the card from the deck. Thus, when the object group is created, it is easy to search among a large number of cards, and the burden on the user can be reduced.

In addition, the object display unit 17C causes the change object information to be displayed in different modes in the candidate display area 22. Since the object display unit 17C causes the change object information to be displayed in the candidate display area 22, it is not necessary to provide a separate display area. Thus, when the screen is narrow, for example, even when a game is played on a smartphone or the like, the change object information can be displayed large. As a result, the change object information can be easily found, so that the burden on the user when the object group is created is reduced.

In addition, the object display unit 17C uses the change information DB4 saved by the saving unit 19 to display the change object information in the candidate display area 22. Thus, the display of the change object information in the candidate display area 22 can be updated in real time. In particular, the user tends to add or exclude the same objects depending on their preferences. Thus, it is possible to easily find the change object by updating the display of the change object information in real time.

Alternatively, the object display unit 17C may cause the change object information to be displayed in the deck display area 21, or may cause the change object information to be displayed in another area different from the deck display area 21 and the candidate display area 22. In addition, the other area may be outside the screen and move into the screen by the swipe operation or the like of the user. Moreover, the other area in the screen may be moved to the outside of the screen by the swipe operation or the like of the user. In other words, the other area may be configured to be movable by the user's operation from the outside of the screen to the inside of the screen or from the inside of the screen to the outside of the screen. Moreover, the object display unit 17C may cause the change object information to be displayed so that the change object information is arranged according to a predetermined rule in accordance with a user's operation (for example, selection of a button). As an example, the predetermined rule is a name order, a type order, a rank order, a level order, an attack power order, a defense power order, a rarity order, an acquisition time order, a popularity order, an appearance time order, and the like. The object display unit 17C can refer to the change information DB4 to rearrange even when the object is displayed in another area. Thus, the burden on the user when the object group is created is reduced. Moreover, the object display unit 17C can give the user an option of the arrangement order of the change object information by referring to the change information DB4.

In the candidate display area 22 of FIG. 6, the change object information and the candidate object information are arranged according to the same predetermined rule. However, the change object information and the candidate object information may be arranged according to different rules, or may be arranged randomly. However, by arranging the change object information and the candidate object information according to the same rule, the user can easily find the change object. In addition, the object display unit 17C may cause only the change object information indicating the change object that has become the target of the change processing within the predetermined period to be displayed in the candidate display area 22. As an example, the predetermined period is within 24 hours, before 24 hours and within 48 hours, before 48 hours and within 72 hours, and the like from the display time point or the composition start time point. Moreover, the predetermined period may be a period from the start of display of the composition screen 20 to the end of display, or a period from the start of display of the composition screen 20 to the confirmation of the deck. For example, the user can select a save button to confirm the deck. Moreover, the predetermined period may be settable by the user.

Moreover, the object display unit 17C may cause the change object information of all or a part of the change objects that have become the targets of the change processing to be displayed. When the part of the change objects is displayed, the part of the change objects may be the change objects that have become the targets of the change processing within a predetermined period (for example, within 24 hours). In addition, the part of the change objects may be change objects that have become the targets of the change processing a predetermined number of times (for example, the number of times exceeding the average number of changes).

Incidentally, the candidate display unit 17B may make the display mode of the candidate object information indicating the object that is not the target of the change processing in the candidate display area 22 different from that of another candidate object. For example, the candidate display unit 17B may weakly display (for example, gray out) the card images CI of the cards that have reached the upper limit number of cards that can be added to the deck. Thus, the user can visually recognize that the card cannot be added to the deck. Alternatively, the candidate display unit 17B may cause the card image CI indicating the card to be non-displayed.

In addition, the object display unit 17C may cause the change object information to be displayed by arranging according to the change timing. Specifically, the object display unit 17C causes the change object information to be displayed in the order of the early change timing or the late change timing. Taking the cards illustrated in FIG. 4 as an example, the object display unit 17C causes the card images CI corresponding to the card numbers “c00001” to “c00004” to be displayed by arranging in this order from the left to the right and from the top to the bottom in the order of earliness. That is, the object display unit 17C causes the card images CI side by side in the order of the change processing. Thus, the user can more easily recognize the change object added or deleted immediately before.

Alternatively, the object display unit 17C causes the card images CI corresponding to the card numbers from “c00004” to “c00001” to be displayed by arranging in this order from the left to the right and from the top to the bottom in the order of lateness. Thus, the user can more easily recognize the change object added or deleted immediately after the start of the composition. Moreover, the object display unit 17C may cause the change object information to be displayed so as to indicate a group of a plurality of added objects or a group of a plurality of excluded objects separately. In addition, the object display unit 17C may further display information (for example, past change date and time) regarding the history of the change object change processing.

In addition, the object display unit 17C may cause the change object information indicating the change object that has become the target of the change processing at the change timing included in a predetermined time period to be displayed in a different mode from that of the change object information indicating the change object that has become the target of the change processing at the change timing not included in the predetermined time period. As an example, in the predetermined time period, a display time point, a composition start time point (for example, a display start time point of the composition screen 20), or the like is a reference time point. For example, the predetermined time period from the reference time point is within 24 hours, before 24 hours and within 48 hours, before 48 hours and within 72 hours, and the like. Alternatively, the predetermined time period may be defined by the number of days, weeks, or months. Incidentally, the predetermined time period may be settable by the user.

For example, the object display unit 17C causes the card image CI indicating the card that has become the target of the change processing within 24 hours from the reference time point to be displayed in a mode surrounded by a red frame line. In addition, the object display unit 17C causes the card image CI indicating the card that has become the target of the change processing before 24 hours and within 48 hours from the reference time point to be displayed in a mode surrounded by an orange frame line. Further, the object display unit 17C causes the card image CI indicating the card that has become the target of the change processing before 48 hours and within 72 hours from the reference time point to be displayed in a mode surrounded by a yellow frame line.

Thus, the burden on the user when the deck is composed is reduced. For example, the user may compose the deck in a predetermined time period according to a holding time of an event in the game or the like. Thus, it is easy to return to the original state of the deck after the end of the event by recognizing the change object that has become the target of the change processing in the predetermined time period. Alternatively, the object display unit 17C may acquire the holding time of the event held in the game from the server 30 and set the time period corresponding to the holding time as the predetermined time period.

In addition, when the selected object is a main object specified from among a plurality of objects, the object display unit 17C may specify a sub-object having a predetermined relationship with the main object. Moreover, the object display unit 17C may cause the sub-object information indicating the specified sub-object to be displayed in a different mode from that of the candidate object information. For example, the main object is an object that the user frequently adds or deletes, an object with that a large number of users associate with the object group in the game, or the like. Moreover, the main object may be an object recommended for use in the event within the game.

Further, the sub-object is, for example, an object that is often added or deleted at the same time as the main object, and is not determined as the main object. For example, an object that needs to be always selected in the game progress is the main object. An object that is not essential but is a useful selection candidate is a sub-object. In addition, the sub-object information is information displayed for the user to recognize the sub-object, and is, for example, the card image CI indicating the sub-object.

Further, as an example of the relationship that is often added or deleted at the same time as the main object, for example, the predetermined relationship is a relationship in which both the change processing for the main object and the change processing for the sub-object are processed during a predetermined length of time. The user tends to add or delete sub-objects for use with the main object at the same time. Thus, it is estimated that the objects whose times of becoming the target of the change processing are close to each other constitute a group of objects that the user consciously or unconsciously uses together. Then, if sub-objects can be visually recognized, the user can more easily create such a group of objects. Thus, the burden on the user when the object group is created is reduced. As an example, the predetermined length is 30 seconds, one minute, five minutes, or the like. Alternatively, the predetermined relationship may be a relationship in which the main object and the sub-object are stored in advance in association with each other.

For example, when the user executes an operation of performing change processing for a selected object, the object display unit 17C refers to data stored in the server storage unit 32 or the terminal storage unit 12. Then, the object display unit 17C determines whether or not the selected object is the main object. Moreover, when being specified as the main object, the object display unit 17C specifies a sub-object having the predetermined relationship. As an example, the main object and the sub-object are specified by the object identification information of the objects classified into each of the main object and the sub-object. Then, the server storage unit 32 or the terminal storage unit 12 stores a table of the object identification information.

Subsequently, the object display unit 17C highlights or weakly displays the sub-object information indicating the sub-object, and makes the display mode different from that of the candidate object information. For example, the object display unit 17C causes the card image CI as the sub-object information to be displayed in a pop-up manner. Incidentally, the object display unit 17C may automatically vary the display mode of the sub-object information, or may vary the display mode according to the user's operation (for example, selection of a button). Moreover, the object display unit 17C may cause the sub-object information to be displayed in a different mode from that of the change object information.

Thus, the user can easily recognize the sub-object to be included in the object group together with the main object. Thus, a burden of creating the object group is reduced. Further, the main object and the sub-object can have a visual correlation. Thus, the user can recognize the sub-object only by selecting the main object. Moreover, it is possible to cause the user to recognize a sub-object reflecting the user's preference.

In addition, the object identification information and the related information may be stored in association with each other. In this case, the object display unit 17C may make the display mode of the change object information different between the change objects based on the related information. For example, the related information includes information regarding the card, information regarding the user, and the like. The information regarding the card includes, for example, parameters such as the attack power or the defense power, information indicating the skill or the special effect, and the like. The information related to the user includes, for example, the number of cards included in the deck, the number of owned cards, information indicating presence or absence of favorite setting, a card name set by the user, and the like.

For example, the object display unit 17C changes the display mode of the change object information based on the number of owned cards. Specifically, the object display unit 17C changes the display mode by displaying a numerical value corresponding to the number of owned cards at the lower right of the card name or the card image CI. In addition, the object display unit 17C may determine whether the number of cards included in the deck reaches the upper limit (for example, a predetermined number of cards such as three sheets or the number of owned cards). When the upper limit is reached, the object display unit 17C grays out the change object information (for example, the card image CI). Incidentally, the candidate display unit 17B may differ the display mode of the candidate object information according to a similar mode.

In addition, the object display unit 17C may cause the change object information to be displayed immediately after the change processing is performed, or may cause the change object information to be displayed after a predetermined time (for example, one minute) has elapsed from the change processing. Moreover, the object display unit 17C may cause the change object information to be displayed according to an operation (for example, selection of a button) by the user. In addition, when the change processing is automatically performed, the object display unit 17C may cause the change object information indicating the change object that has automatically become the target of the change processing to be displayed in a different mode. In this case, the saving unit 19 saves the change information DB4 in association with the object identification information for identifying the change object that has automatically become the target of the change processing. Alternatively, the object display unit 17C does not need to display the change object information indicating the change object that has automatically become the target of the change processing in a different mode.

Further, the object display unit 17C may cause the change object information indicating the change object subjected to the selection change processing to be displayed in a different mode from that of the change object information indicating the change object subjected to the cancellation change processing. In this case, the saving unit 19 saves the change information DB4 including the type of change processing. Moreover, when the user selects the change object information indicating the change object subjected to the selection change processing, the change unit 18 may execute the selection change processing for the change object. For example, when the card image CI of the added card is selected, the change unit 18 adds the same card as the card to the deck. In addition, when the user selects the change object information indicating the change object subjected to the cancellation change processing, the change unit 18 may execute the cancellation change processing for the change object. For example, when the card image CI of the excluded card is selected, the change unit 18 excludes the same card as the card from the deck.

### Server Configuration

The configuration of the server 30 will be described with reference to FIG. 2. The server control unit 31 of the server 30 is configured as a computer, and includes a processor (not illustrated). The processor is, for example, a CPU or an MPU, and controls the entire server 30 based on a program stored in the server storage unit 32 and also controls various processes in an integrated manner. Alternatively, the server control unit 31 can also perform control according to a program stored in a portable recording medium such as a CD, a DVD, a CF card, or a USB memory, or an external storage medium. Further, the server control unit 31 is connected to an operation unit (not illustrated) including a keyboard or various switches for inputting predetermined commands and data, in a wired or wireless manner. Moreover, a display unit (not illustrated) that causes an input state, a setting state, a measurement result, and various types of information of the device to be displayed is connected to the server control unit 31 in a wired or wireless manner.

The server storage unit 32 is a computer-readable non-transitory storage medium. Specifically, the server storage unit 32 includes a storage apparatus such as a RAM, a ROM, an HDD, and an SSD. Further, the server storage unit 32 stores information regarding the user in addition to the above-described information. The information regarding the user is, for example, the user identification information, the game result of the user, the user name, and the like.

In addition, the server storage unit 32 may store image data for causing the composition screen 20 and the like to be displayed on the game terminal 10. Moreover, the server storage unit 32 may store data such as image data or music data necessary for the progress of the game, update data of the control program PG, and the like. A server communication unit 33 is a communication module, a communication interface, or the like. Then, the server communication unit 33 enables transmission and reception of data between the game terminal 10 and the server 30 via the network 50.

### Display Processing of Change Object Information

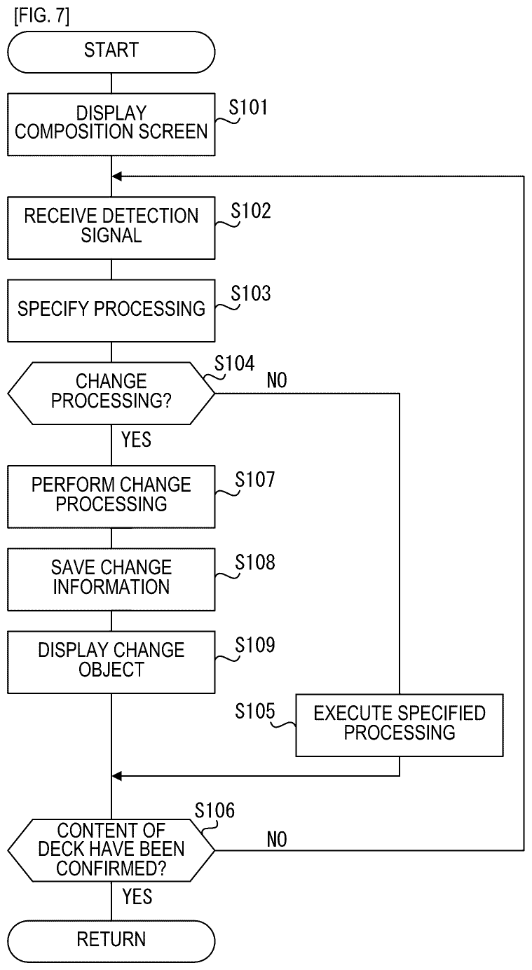

Display processing of the change object information executed in the game system 100 will be described with reference to FIG. 7. For example, the display processing is executed by the terminal control unit 11 executing the control program PG stored in the terminal storage unit 12. In addition, the terminal control unit 11 and the server control unit 31 may execute the display processing in cooperation.

Upon receiving the operation of selecting the composition mode by the user, the terminal control unit 11 transmits an acquisition request of information necessary for displaying the composition screen 20 to the server 30. For example, the necessary information is information included in the card information DB1 and information included in the owned card information DB2. The acquisition request includes the deck identification information of a deck selected by the user as the target of composition or a deck newly created by the user, and user identification information. Then, the game terminal 10 acquires necessary information from the server 30.

Subsequently, the display control unit 17 of the game terminal 10 causes the composition screen 20 to be displayed on the terminal display unit 15 based on the received information (S101). When displaying the composition screen 20, the candidate display unit 17B causes the candidate object information indicating candidate objects to be displayed on the composition screen 20. Alternatively, the display control unit 17 may cause the composition screen 20 to be displayed based on the information stored in the terminal storage unit 12. Moreover, the display control unit 17 may cause the composition screen 20 to be displayed so as to reproduce the past display state. At least one of the terminal storage unit 12 or the server storage unit 32 can save information for reproducing the past display state.

Subsequently, when the user performs an operation using the terminal operation unit 14, the terminal control unit 11 receives a detection signal of the terminal operation unit 14 (S102). Then, the terminal control unit 11 specifies processing corresponding to the operation by the user based on the detection signal of the terminal operation unit 14 (S103). Then, the terminal control unit 11 determines whether or not the processing corresponding to the operation is the change processing (S104). When determining that the processing is not the change processing (NO in S104), the terminal control unit 11 executes the specified processing (S105). Specifically, when the user performs an operation of selecting a button, the terminal control unit 11 executes, for example, processing of displaying the content of the card, or the like as processing corresponding to the button.

Thereafter, when the user performs an operation of confirming the content of the deck (for example, an operation of selecting the save button), the terminal control unit 11 determines that the content of the deck have been confirmed (YES in S106) and ends the processing. On the other hand, when the operation of confirming the content of the deck is not performed (NO in S106), the terminal control unit 11 returns to a state of waiting for reception of the detection signal.

In the determination of the change processing (S104), when the user performs an operation of adding a card, the terminal control unit 11 determines whether or not the card image CI has been dragged and dropped from the candidate display area 22 to the deck display area 21. Then, when determining that the dropped position is within the deck display area 21, the terminal control unit 11 determines that the change processing of adding the card has been performed. In addition, in the determination of the change processing (S104), when the user performs an operation of excluding a card, the terminal control unit 11 determines whether or not the card image CI has been dragged and dropped from the deck display area 21 to the candidate display area 22. Then, when determining that the dropped position is within the candidate display area 22, the terminal control unit 11 determines that the change processing of excluding the card has been performed.

Then, when determining that the change processing has been performed (YES in S104), the change unit 18 performs the change processing including at least one of the selection change or the cancellation change (S107). For example, when the user performs the operation of adding a card, the change unit 18 associates the selected card selected by the user with the deck. Then, the change unit 18 associates the deck ID with the card number and the serial number of the card selected by the user, and includes them in the composition information 12A. Further, the group display unit 17A causes the card image CI indicating the card added to the deck to be displayed in the deck display area 21. In addition, when the user performs an operation of excluding the card, the change unit 18 cancels the association between the selected card selected by the user and the deck. Then, the change unit 18 deletes the card number and the serial number of the card selected by the user, which are associated with the deck ID, from the composition information 12A. Moreover, the group display unit 17A causes the card image CI indicating the card excluded from the deck to be non-displayed in the deck display area 21.

Further, the saving unit 19 saves the change information DB4 indicating that the change processing has been performed in association with the object identification information for identifying the change object (S108). Specifically, the saving unit 19 stores the change timing or the number of changes associated with the card ID in the composition information 12A. Incidentally, the saving unit 19 may store the change information DB4 in the card information DB1 of the database DB instead of or in addition to the composition information 12A. Then, the object display unit 17C refers to the change information DB4 and displays the change object in a different mode (S109).

For example, the object display unit 17C searches for a card ID included in the change information DB4. Then, the object display unit 17C causes the card image CI indicating the change card identified by the card ID obtained by the search to be displayed weakly or highlighted. Thereafter, when the user performs an operation of confirming the content of the deck (for example, an operation of selecting the save button), the terminal control unit 11 determines that the content of the deck have been confirmed (YES in S106) and ends the processing. On the other hand, when the operation of confirming the content of the deck is not performed (NO in S106), the terminal control unit 11 returns to a state of waiting for reception of the detection signal.

Then, when the user performs an operation of confirming the content of the deck, the terminal control unit 11 transmits a save request of the composed deck to the server 30. The save request includes the composition information 12A. Then, the server control unit 31 updates the content of the deck information DB3 associated with the user ID of the user based on the composition information 12A. Further, when the change processing is performed, the saving unit 19 transmits a save request for the change information DB4 to the server 30. The save request includes a card ID and change information DB4. Then, the server control unit 31 updates the content of the card information DB1 associated with the user ID of the user.

With the game system 100 described above, the change object information indicating the change object that has become the target of the change processing is displayed in different modes. Thus, the user can visually recognize the object to which the change such as addition or exclusion has been made. Thus, it is possible to reduce time and effort for searching among a large number of candidate objects, so that a burden on the user when the object group is created is reduced. In particular, since the object display unit 17C causes the change object information to be displayed in the candidate display area 22, it is not necessary to separately provide an area for display. Thus, even when the terminal display unit 15 is narrow, the display area can be secured without reducing the size of the change object information.

### Second Embodiment

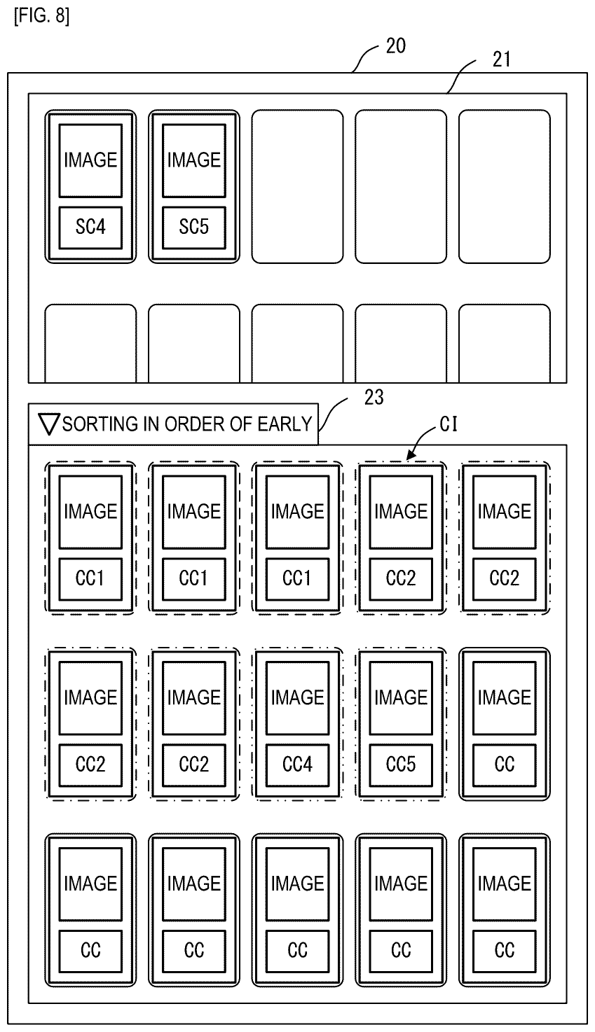

A second embodiment will be described with reference to FIG. 8. The second embodiment is different from the first embodiment in that the second embodiment has a function of rearranging or narrowing change object information. Incidentally, in the description of the second embodiment, differences from the first embodiment will be described. The already described components are denoted by the same reference signs, and the description thereof will be omitted. Unless otherwise described, the components denoted by the same reference signs exhibit substantially the same operation and function, and the functions and effects thereof are also substantially the same.

The composition screen 20 illustrated in FIG. 8 is provided with a pull-down menu 23 for implementing a function of sorting or narrowing. The user selects a desired sorting rule from the pull-down menu 23. For example, FIG. 8 illustrates a state in which the user has selected a rule for sorting in order of early change timing. Then, the object display unit 17C causes the card images CI indicating the change cards CC1 those have become the targets of the change processing earlier and surrounded by broken lines to be displayed on the upper left. Then, the object display unit 17C causes the card images CI indicating the change cards CC2 those have become the targets of the change processing later and surrounded by one-dot chain line to be displayed on the right side or the lower side. For example, the change card CC1 is the target of the change processing before 24 hours from the display time point. Further, the change card CC2 is the target of the change processing within 24 hours from the display time point.

Moreover, in the example of FIG. 8, change cards CC4 and CC5 are added to the deck as change objects. Thus, the group display unit 17A causes the card images CI indicating the selected cards SC4 and SC5 as the selected objects to be displayed in the deck display area 21. In addition, the object display unit 17C causes the card images CI as the change object information indicating the change cards CC4 and CC5 to be displayed in a different mode from that of the card images CI indicating the other candidate cards CC.

Specifically, the object display unit 17C causes the card images CI indicating the change cards CC4 and CC5 and surrounded by a two-dot chain line to be displayed in the candidate display area 22 in a mode surrounded by an orange frame line, for example. Thus, the object display unit 17C varies the display mode depending on the presence or absence of the frame line and the color of the frame line. Furthermore, the change cards CC4 and CC5 have been added most recently. Thus, the object display unit 17C causes the card images CI indicating the change cards CC4 and CC5 those have become the targets of the change processing later to be displayed on the right side of or below the change card CC2.

Alternatively, the object display unit 17C may rearrange pieces of the change object information in time series. That is, the object display unit 17C may execute rearrangement so that the change object information of the change object that has become the target of the change processing earliest or latest is positioned at the upper left. Further, after the rearrangement, the object display unit 17C may cause the change object information indicating the change object that has become the target of the change processing at the change timing included in a predetermined time period to be displayed in a different mode from that of the change object information indicating the change object that has become the target of the change processing at the change timing not included in the predetermined time period.

Other examples of the sorting rule include a name order, a type order, a rank order, a level order, an attack power order, a defense power order, a rarity order, an acquisition time order, a popularity order, an appearance time order, and the like. Moreover, other examples of the sorting rule may include the order of the numbers of changes in descending order or ascending order, or the order of the numbers of changes by the moving average in descending order or ascending order. In addition, the user may select a desired narrowing rule from the pull-down menu 23. For example, examples of the narrowing rule include a type, an attribute, a race, a level, a rank, rarity, an effect of the card, and the like. For example, in the case of narrowing down depending on the type of the card, when the user selects a monster as a narrowing condition, the object display unit 17C causes only the card image CI of the change card of the monster to be displayed.

In this manner, by rearranging or narrowing down, the user can efficiently find a target object from among a large number of objects. That is, the user can more easily find a desired change object to be the target of the change processing. Incidentally, instead of the pull-down menu 23, a function of sorting or narrowing may be executed by selection of a button or input to an input field. In addition, the candidate object information may be displayed according to the same sorting or narrowing rule as the change object information. In addition, the candidate object information may be rearranged or narrowed down separately from the change object information.

Hitherto, the present invention has been described with reference to each embodiment, but the present invention is not limited to the above embodiments. Inventions modified within a range without contradictory to the present invention and inventions equivalent to the present invention are also included in the present invention. In addition, each embodiment, each modification, and technical means included in each embodiment or each modification can be appropriately combined within a range without contradictory to the present invention.

For example, at least one of the display control unit 17, the change unit 18, the saving unit 19, the group display unit 17A, the candidate display unit 17B, or the object display unit 17C may be provided in the server control unit 31. As a specific example, the server control unit 31 may function as the display control unit 17 to cause the composition screen 20 and the like to be displayed on the terminal display unit 15 of the game terminal 10. Alternatively, the processing performed as the display control unit 17 may be shared between the terminal control unit 11 and the server control unit 31, and the terminal control unit 11 and the server control unit 31 may function as the display control unit 17 in cooperation. Similarly, the terminal control unit 11 and the server control unit 31 may function as the change unit 18 or the saving unit 19 in cooperation.

In addition, the object display unit 17C may cause only the change object information indicating the change object subjected to the selection change processing to be displayed in a different mode. For example, the object display unit 17C may cause only the card image CI indicating the added card to be displayed in a different mode. Moreover, the object display unit 17C may cause only the change object information indicating the change object subjected to the cancellation change processing to be displayed in a different mode. For example, the object display unit 17C may cause only the card image CI indicating the excluded card in a different mode.

Hereinafter, various modes derived from the above-described embodiments and modifications will be described. Furthermore, in order to facilitate understanding of each mode, reference signs illustrated in the accompanying drawings are added. However, the reference signs are not intended to limit the present invention to the illustrated form.

A game system (100) that creates an object group with which a plurality of objects is associated, the game system comprises: a candidate display portion (17B) that causes candidate object information, which indicates candidate objects to be associated with the object group, to be displayed on a screen (20); a change portion (18) that performs change processing including at least one of a selection change of associating a selected object selected from the candidate objects with the object group, or a cancellation change of cancelling association between the selected object and the object group; a saving portion (19) that saves change information (DB4) indicating that the change processing has been performed in association with object identification information for identifying a change object that has become a target of the change processing; and an object display portion (17C) that causes change object information indicating the change object to be displayed in a different mode from the candidate object information with reference to the change information.

Further, a control program (PG) for a game system (100) that creates an object group with which a plurality of objects is associated, the control program causes a computer (11) to function as: a candidate display portion (17B) that causes candidate object information, which indicates candidate objects to be associated with the object group, to be displayed on a screen (20); a change portion (18) that performs change processing including at least one of a selection change of associating a selected object selected from the candidate objects with the object group, or a cancellation change of cancelling association between the selected object and the object group; a saving portion (19) that saves change information (DB4) indicating that the change processing has been performed in association with object identification information for identifying a change object that has become a target of the change processing; and an object display portion (17C) that causes change object information indicating the change object to be displayed in a different mode from the candidate object information with reference to the change information.

In addition, a control method for a game system (100) that creates an object group with which a plurality of objects is associated, the control method comprises: causing (S101) candidate object information, which indicates candidate objects to be associated with the object group, to be displayed on a screen (20); performing (S107) change processing including at least one of a selection change of associating a selected object selected from the candidate objects with the object group, or a cancellation change of cancelling association between the selected object and the object group; saving (S108) change information (DB4) indicating that the change processing has been performed in association with object identification information for identifying a change object that has become a target of the change processing; and causing (S109) change object information indicating the change object to be displayed in a different mode from the candidate object information with reference to the change information.

The saving portion (19) saves a change timing at which the change processing is performed as the change information (DB4).

The saving portion (19) saves the number of changes for which the change processing has been performed as the change information (DB4).

The candidate display portion (17B) causes the candidate object information to be displayed in a candidate display area (22) of the screen (20), and the object display portion (17C) causes the change object information to be displayed in the candidate display area in the different mode.

The change portion (18) performs the change processing on each of the plurality of object groups. Further, the saving portion (19) saves the change information so that the change information (DB4) of the change processing previously performed on at least one change object is replaced with the change information of the change processing later performed on the at least one change object.

The object display portion (17C) causes the change object information indicating the change object, which has become the target of the change processing at the change timing included in a predetermined time period, to be displayed in a different mode from the change object information indicating the change object which has become the target of the change processing at the change timing not included in the predetermined time period.

When the selected object is a main object specified from among the plurality of objects, the object display portion (17C) specifies a sub-object having a predetermined relationship with the main object, and causes sub-object information indicating the sub-object to be displayed in a different mode from the candidate object information.

The predetermined relationship is a relationship in which the change processing for the main object and the change processing for the sub-object are executed during a predetermined length of time.

The selection change is processing of adding the selected object to the object group, and the cancellation change is processing of excluding the selected object included in the object group from the object group.

The object display portion (17C) causes the change object information to be displayed in the different mode by causing the change object information to be displayed at a position above the candidate object information on the screen (20).

The object display portion (17C) causes the change object to be displayed by arranging according to the change timing.

What is claimed is:

1. A game system that creates an object group with which a plurality of objects is associated, the game system comprising:
a computer that causes candidate object information, which indicates candidate objects to be associated with the object group, to be displayed on a screen;
the computer that performs change processing including at least one of a selection change of associating a selected object selected from the candidate objects with the object group, or a cancellation change of cancelling association between the selected object and the object group;
the computer that saves change information indicating that the change processing has been performed in association with object identification information for identifying a change object that has become a target of the change processing; and
the computer that causes change object information indicating the change object to be displayed in a different mode from the candidate object information with reference to the change information.

2. The game system according to claim 1, wherein the computer saves a change timing at which the change processing is performed as the change information.

3. The game system according to claim 1, wherein the computer saves the number of changes for which the change processing has been performed as the change information.

4. The game system according to claim 1, wherein the computer causes the candidate object information to be displayed in a candidate display area of the screen, and
the computer causes the change object information to be displayed in the candidate display area in the different mode.

5. The game system according to claim 1, wherein the computer performs the change processing on each of the plurality of object groups.

6. The game system according to claim 1, wherein the computer saves the change information so that the change information of the change processing previously performed on at least one change object is replaced with the change information of the change processing later performed on the at least one change object.

7. The game system according to claim 2, wherein the computer causes the change object information indicating the change object, which has become the target of the change processing at the change timing included in a predetermined time period, to be displayed in a different mode from the change object information indicating the change object which has become the target of the change processing at the change timing not included in the predetermined time period.

8. The game system according to claim 1, wherein, when the selected object is a main object specified from among the plurality of objects, the computer specifies a sub-object having a predetermined relationship with the main object, and causes sub-object information indicating the sub-object to be displayed in a different mode from the candidate object information.

9. The game system according to claim 8, wherein the predetermined relationship is a relationship in which the change processing for the main object and the change processing for the sub-object are executed during a predetermined length of time.

10. The game system according to claim 1, wherein the selection change is processing of adding the selected object to the object group, and the cancellation change is processing of excluding the selected object included in the object group from the object group.

11. The game system according to claim 1, wherein the computer causes the change object information to be displayed in the different mode by causing the change object information to be displayed at a position above the candidate object information on the screen.

12. The game system according to claim 2, wherein the computer causes the change object to be displayed by arranging according to the change timing.

13. A computer-readable non-transitory storage medium storing a control program for a game system that creates an object group with which a plurality of objects is associated, the control program causing a computer to:
cause candidate object information, which indicates candidate objects to be associated with the object group, to be displayed on a screen;
perform change processing including at least one of a selection change of associating a selected object selected from the candidate objects with the object group, or a cancellation change of cancelling association between the selected object and the object group;
save change information indicating that the change processing has been performed in association with object identification information for identifying a change object that has become a target of the change processing; and
cause change object information indicating the change object to be displayed in a different mode from the candidate object information with reference to the change information.

14. A control method for a game system that creates an object group with which a plurality of objects is associated, the control method comprising:
causing candidate object information, which indicates candidate objects to be associated with the object group, to be displayed on a screen;
performing change processing including at least one of a selection change of associating a selected object selected from the candidate objects with the object group, or a cancellation change of cancelling association between the selected object and the object group;
saving change information indicating that the change processing has been performed in association with object identification information for identifying a change object that has become a target of the change processing; and
causing change object information indicating the change object to be displayed in a different mode from the candidate object information with reference to the change information.
